(19) United States
(12) Patent Application Publication
(10) Pub. No.: US 2014/0060003 A1
(43) Pub. Date: Mar. 6, 2014

(54) TURBOMACHINE HAVING A FLOW MONITORING SYSTEM AND METHOD OF MONITORING FLOW IN A TURBOMACHINE

(71) Applicant: Alan Donn Maddaus, Rexford, NY (US)

(72) Inventor: Alan Donn Maddaus, Rexford, NY (US)

(73) Assignee: GENERAL ELECTRIC COMPANY, Schenectady, NY (US)

(21) Appl. No.: 13/605,259

(22) Filed: Sep. 6, 2012

(51) Int. Cl. F01K 23/06; F02C 6/04; F01D 25/00

(52) U.S. Cl. 60/39.182; 415/118; 415/1

(57) ABSTRACT

A turbomachine includes a turbine portion having a housing enclosing one or more turbine stages. Each of the one or more turbine stages includes a plurality of turbine buckets. The plurality of turbine buckets include an upstream portion and a downstream portion. A first sensor is mounted in the turbine portion at the upstream portion of plurality of turbine buckets and a second sensor is mounted in the turbine portion at the downstream portion of the plurality of turbine buckets. A controller is operatively coupled to the first and second sensors. The controller is configured and disposed to detect a change in flow between the upstream portion and the downstream portion and signal an alarm if the change in flow falls below a predetermined threshold value.

### BACKGROUND OF THE INVENTION

The subject matter disclosed herein relates to the art of turbomachines and, more particularly, to a turbomachine having a flow monitoring system.

Many turbomachines include a compressor portion linked to a turbine portion through a common compressor/turbine shaft or rotor and a combustor assembly. The compressor portion guides compressed air flow through a number of sequential stages toward the combustor assembly. In the combustor assembly, the compressed air flow mixes with a fuel to form a combustible mixture. The combustible mixture is combusted in the combustor assembly to form hot gases. The hot gases are guided to the turbine portion through a transition piece. The hot gases expand through the turbine portion rotating turbine blades to create work that is output, for example, to power a generator, a pump, or to provide power to a vehicle. In addition to providing compressed air for combustion, a portion of the compressed airflow is passed through the turbine portion for cooling purposes.

### BRIEF DESCRIPTION OF THE INVENTION

According to one aspect of an exemplary embodiment, a turbomachine includes a turbine portion having a housing enclosing one or more turbine stages. Each of the one or more turbine stages includes a plurality of turbine buckets. The plurality of turbine buckets include an upstream portion and a downstream portion. A first sensor is mounted in the turbine portion at the upstream portion of plurality of turbine buckets and a second sensor is mounted in the turbine portion at the downstream portion of the plurality of turbine buckets. A controller is operatively coupled to the first and second sensors. The controller is configured and disposed to detect a change in flow between the upstream portion and the downstream portion and signal an alarm if the change in flow falls below a predetermined threshold value.

According to another aspect of an exemplary embodiment, a combined cycle power plant includes a gas turbomachine including a compressor portion, a turbine portion, and a combustor assembly fluidically connected to the compressor portion and the turbine portion. A heat recovery steam generator is fluidically connected to the turbine portion. A steam turbine is fluidically connected to the heat recovery steam generator. The steam turbine includes a housing enclosing one or more turbine stages. Each of the one or more turbine stages includes a plurality of turbine buckets. The plurality of turbine buckets includes an upstream portion and a downstream portion. A first sensor is mounted in the turbine portion at the upstream portion of plurality of turbine buckets. A second sensor is mounted in the turbine portion at the downstream portion of the plurality of turbine buckets. A controller is operatively coupled to the first and second sensors. The controller is configured and disposed to detect a change in flow between the upstream portion and the downstream portion and signal an alarm if the change in flow falls below a predetermined threshold value.

According to yet another aspect of an exemplary embodiment, a method of operating a turbomachine includes, sensing a first flow parameter upstream of a turbine bucket, sensing a second flow parameter downstream of the turbine bucket, calculating a difference between the first flow parameter and the second flow parameter, and initiating an alarm if the difference between the first flow parameter and the second flow parameter exceeds a predetermined threshold value.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a turbomachine including a flow monitoring system in accordance with an exemplary embodiment;

FIG. 2 is a flow chart illustrating a method of monitoring flow in the turbomachine of FIG. 1; and

FIG. 3 is a graph illustrating changes in flow in the turbomachine of FIG. 1.

The detailed description explains embodiments of the invention, together with advantages and features, by way of example with reference to the drawings.

### DETAILED DESCRIPTION OF THE INVENTION

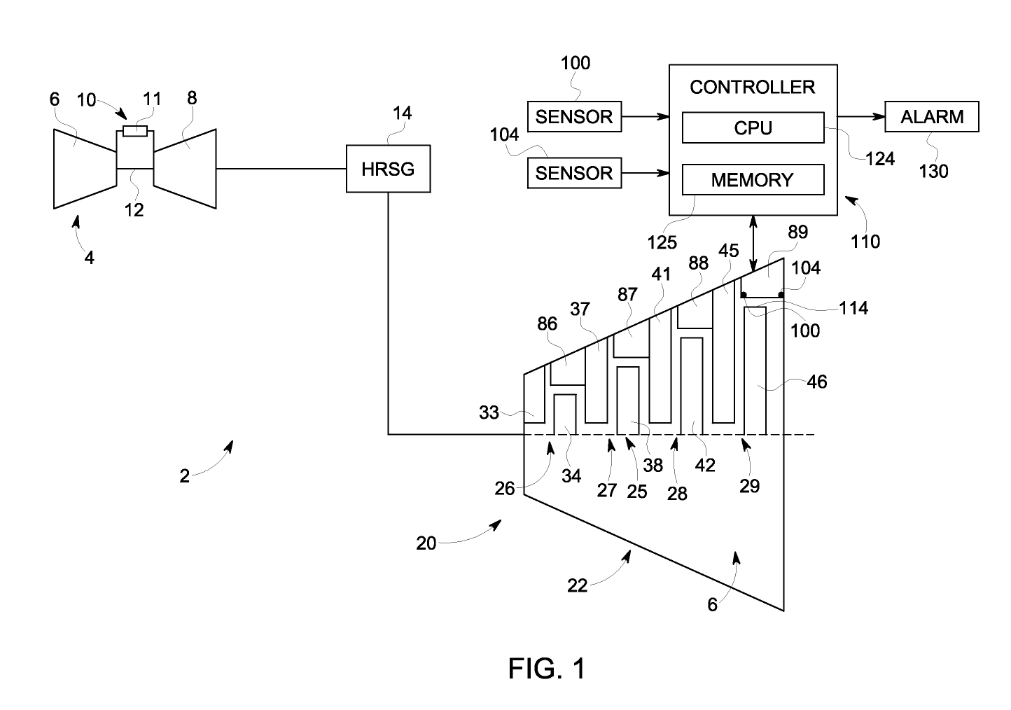

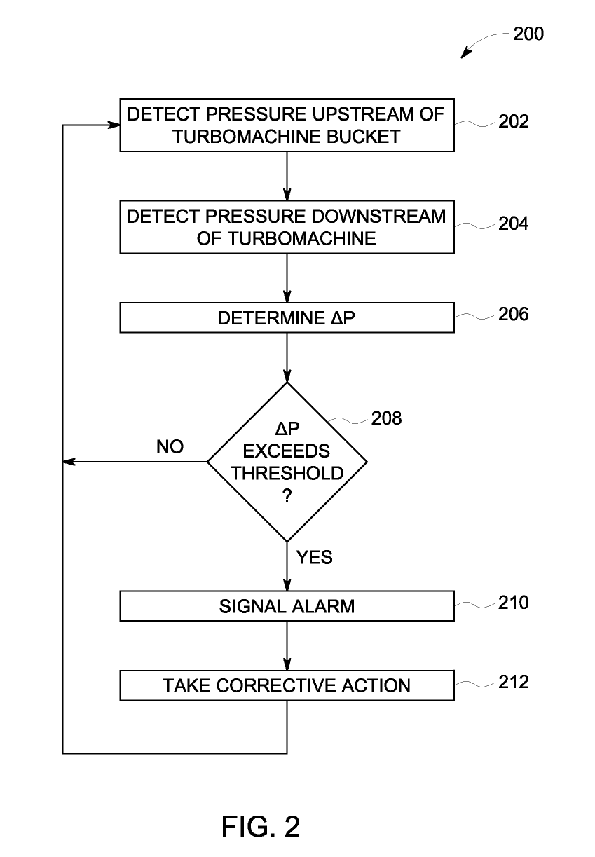

With reference to FIGS. 1 and 2, a combined cycle power plant (CCPP) in accordance with an exemplary embodiment is indicated generally at 2. CCPP 2 includes a gas turbomachine 4 having a compressor portion 6 and a turbine portion 8. Compressor portion 6 is fluidly connected to turbine portion 8 through a combustor assembly 10. Combustor assembly 10 includes a plurality of combustors, one of which is indicated at 11. Combustors 11 may be arranged in a can-annular array about gas turbomachine 4. Of course it should be understood that other arrangements of combustors 11 may also be employed. Compressor portion 6 is also mechanically linked to turbine portion 8 through a common compressor/turbine shaft 12. Exhaust from turbine portion 8 is passed to a heat recovery steam generator (HRSG) 14. The exhaust gases exchange heat with water to form steam that is guided to a steam turbine 20.

Steam turbine portion 20 includes a housing 22 that encloses a plurality of turbine stages 25. Turbine stages 25 include a first turbine stage 26, a second turbine stage 27, a third turbine stage 28, and a fourth turbine stage 29. First turbine stage 26 includes a first plurality of vanes or nozzles 33 and a first plurality of rotating components in the form of blades or buckets 34. Buckets 34 are mounted to a first rotor member (not shown) that is coupled to shaft 12. Second turbine stage 27 includes a second plurality of vanes or nozzles 37 and a second plurality of blades or buckets 38. Buckets 38 are coupled to a second rotor member (also not shown). Third turbine stage 28 includes a third plurality of vanes or nozzles 41 and a third plurality of blades or buckets 42 that are coupled to a third rotor member (also not shown). Fourth turbine stage 29 includes a fourth plurality of vanes or nozzles 45 and a fourth plurality of blades or buckets 46 that are coupled to a fourth rotor member (not shown). Buckets 46 represent last stage or aft-most buckets in steam turbine 20. Of course it should be understood that the number of turbine stages may vary. Steam turbine 20 is also shown to include a plurality of stationary turbine shrouds 86-89 supported to housing 22. Turbine shrouds 86-89 provide a desired clearance between an inner surface (not separately labeled) of housing 22 and tip portions (not separately labeled) of corresponding ones of buckets 34, 38, 42, and 46. Turbine shrouds 86-89 are arranged in a ring circumscribing corresponding ones of turbine stages 25-29.

In accordance with an exemplary embodiment, steam turbine 20 includes a first sensor 100 arranged upstream of buckets 46 and a second sensor 104 arranged downstream of buckets 46. Sensors 100 and 104 provide signals to a controller 110 that is programmed to determine flow across buckets 46. More specifically, controller 110 is programmed to calculate a pressure difference (ΔP) across tip portions 114 of buckets 46. Sensor 100 provides a signal representative of P₁ and sensor 104 provides a signal representative of P₂. Controller 110 is shown to include a central processor unit (CPU) 124 and a memory 125. Memory 125 may be configured to store pressure values obtained from sensors 100 and 104 over a period of time. As will become more fully evident below, controller 110 provides an output to an alarm 130 if ΔP falls below a predetermined threshold value. In accordance with an aspect of the exemplary embodiment, during normal operation of steam turbine portion 20, ΔP=P₁−P₂ should be a positive value. A positive value represents operation in a turbine mode, or a mode in which pressure decreases in a direction of flow of gases through steam turbine portion 20. If, however, ΔP falls below a predetermined value or trends toward a negative value, alarm 130 is activated to signal the presence of a condition of interest in steam turbine 20. The condition of interest represents operation in a compressor mode or a mode in which pressure increases in the direction of flow over tip portions 114. The condition of interest may result in blade flutter, vibrations due to flow instability, or the like.

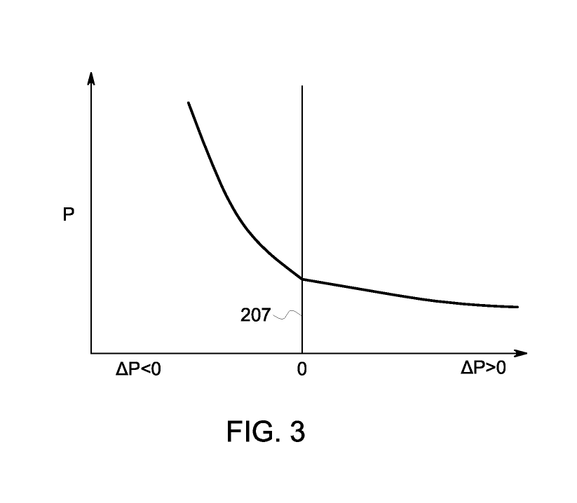

Reference will now be made to FIG. 2 in describing a method 200 of monitoring flow in steam turbine 20. Controller 110 determines a first pressure value P₁ based on data received from sensor 100 as shown in block 202. Controller 110 also determines a second pressure value P₂ based on data received from sensor 104 as shown in block 204. Controller 110 then determines ΔP (P₁−P₂) as shown in block 206. If ΔP remains above a predetermined threshold value 207 (See FIG. 3), controller 110 continues to detect pressures without signaling any action as shown in block 208. However, if ΔP falls below a predetermined threshold value 207, alarm 130 is initiated as shown in block 210. Alarm 130 may be an audible alarm, or a visual alarm to an operator. After receiving the alarm, the operator may take corrective measures as shown in block 212. Corrective measures may include taking steps that lead to increased flow or a decrease in exhaust pressure. It has been found that at a ΔP below value 207, tip portions 114 of buckets 46 begin to behave in a manner similar to a compressor blade. Airflow/combustion products (gas turbine) or steam flow (steam turbine) across buckets 46 begin to detach from airfoils surfaces (not separately labeled) creating undesirable vibrations or flutter. Vibrations or flutter may lead to undesirable noise or internal damage.

At this point it should be understood that the exemplary embodiments provide a system for monitoring flow characteristics through a turbomachine. Flow parameters monitored in accordance with the example embodiments have been found to be early indicators or warnings of potential vibrations or flutter in the turbine. Early warnings provided by the monitoring system of the exemplary embodiment allow operators to take corrective measures before vibrations/flutters reach undesirable levels. At this point it should be understood that while shown and described as monitoring pressures at the aft-most, or last stage turbine buckets, the exemplary embodiments may be positioned in other locations in the turbine. Further, while shown and described as being employed in connection with a steam turbine, the exemplary embodiments may be incorporated into a gas turbine and/or a compressor.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A turbomachine comprising:
a turbine portion including a housing enclosing one or more turbine stages, each of the one or more turbine stages including a plurality of turbine buckets, the plurality of turbine buckets including an upstream portion and a downstream portion;
a first sensor mounted in the turbine portion at the upstream portion of the plurality of turbine buckets;
a second sensor mounted in the turbine portion at the downstream portion of the plurality of turbine buckets; and
a controller operatively coupled to the first and second sensors, the controller being configured and disposed to detect a change in flow between the upstream portion and the downstream portion and signal an alarm if the change in flow falls below a predetermined threshold value.

2. The turbomachine according to claim 1, wherein each of the first and second sensors is a pressure sensor, the controller being configured and disposed to detect a pressure change over a tip portion of the plurality of turbine buckets.

3. The turbomachine according to claim 1, wherein the one or more turbine stages comprises an aft-most stage turbine buckets of the turbine portion.

4. The turbomachine according to claim 1, wherein each of the first and second sensors is mounted to an inner surface of the housing.

5. The turbomachine according to claim 4, wherein the inner surface of the housing comprises a turbine shroud.

6. The turbomachine according to claim 1, wherein the turbine portion comprises a steam turbine.

7. A combined cycle power plant (CCPP) comprising:
a gas turbomachine including a compressor portion, a turbine portion, and a combustor assembly fluidically connected to the compressor portion and the turbine portion;
a heat recovery steam generator (HRSG) fluidically connected to the turbine portion;
a steam turbine is fluidically connected to the heat recovery steam generator, the steam turbine including a housing enclosing one or more turbine stages, each of the one or more turbine stages including a plurality of turbine buckets, the plurality of turbine buckets including an upstream portion and a downstream portion;
a first sensor mounted in the turbine portion at the upstream portion of one of the plurality of turbine buckets;
a second sensor mounted in the turbine portion at the downstream portion of the plurality of turbine buckets; and
a controller operatively coupled to the first and second sensors, the controller being configured and disposed to detect a change in flow between the upstream portion and the downstream portion and signal an alarm if the change in flow falls below a predetermined threshold value.

8. The combined cycle power plant according to claim 7, wherein each of the first and second sensors is a pressure sensor, the controller being configured and disposed to detect a pressure change over a tip portion of the plurality of turbine buckets.

9. The combined cycle power plant according to claim 7, wherein the one or more turbine stages comprises an aft-most stage of the steam turbine.

10. The combined cycle power plant according to claim 7, wherein each of the first and second sensors is mounted to an inner surface of the housing.

11. The combined cycle power plant according to claim 10, wherein the inner surface of the housing comprises a turbine shroud.

12. A method of monitoring flow in a turbomachine comprising:
sensing a first flow parameter upstream of a turbine bucket;
sensing a second flow parameter downstream of the turbine bucket;
calculating a difference between the first flow parameter and the second flow parameter; and
initiating an alarm if the difference between the first flow parameter and the second flow parameter falls below a predetermined threshold value.

13. The method of claim 12, wherein sensing the first and second flow parameters comprises sensing a first pressure upstream of the turbine bucket and a second pressure downstream of the turbine bucket.

14. The method of claim 13, wherein sensing the first pressure upstream of the turbine bucket includes sensing the first pressure upstream of a tip portion of the turbine bucket and sensing the second pressure downstream of the turbine bucket includes sensing the second pressure downstream of the tip portion.

15. The method of claim 12, wherein sensing the first and second flow parameters comprises sensing first and second flow parameters of a turbine bucket in an aft-most stage of the steam turbine.

16. The method of claim 12, wherein sensing the first and second flow parameters comprises sensing first and second flow parameters of a turbine bucket in a steam turbine.

17. The method of claim 12, wherein initiating an alarm includes providing one of a visual indication and an audible indication if the difference between the first and second flow parameters is a negative value.

18. The method of claim 12, further comprising: adjusting an operating mode of the turbomachine if the difference between the first flow parameter and the second flow parameter falls below the predetermined threshold value.

19. The method of claim 18, wherein adjusting an operating mode of the turbomachine includes establishing an operating mode that reduces exhaust pressure in the turbomachine.

20. The method of claim 12, further comprising: detecting an increase in vibration of the turbomachine correlated to the difference between the first flow parameter and the second flow parameter falling below the predetermined threshold value.
